(19) United States
(12) Patent Application Publication
(10) Pub. No.: US 2022/0383206 A1
(43) Pub. Date: Dec. 1, 2022

(54) Task Augmentation and Self-Training for Improved Few-Shot Learning

(71) Applicant: Google LLC, Mountain View, CA (US)

(72) Inventors: Thang Minh Luong, Santa Clara, CA (US); Tu Thanh Vu, Amherst, MA (US); Quoc V. Le, Sunnyvale, CA (US); Grady Hayes Simon, Washington, DC (US)

(21) Appl. No.: 17/826,690

(22) Filed: May 27, 2022

Related U.S. Application Data
(60) Provisional application No. 63/194,474, filed on May 28, 2021.

(51) Int. Cl. G06N 20/20; G06K 9/62

(52) U.S. Cl. CPC G06N 20/20; G06K 9/623; G06K 9/6259

(57) ABSTRACT

Systems and methods can leverage task-specific unlabeled data to improve downstream performance in data-constrained scenarios. Given a target task, a first technique proposed herein, which can be referred to as task augmentation, uses unlabeled text from the target domain to synthesize a large amount of in-domain training data for an auxiliary task A second technique provides a self-training algorithm, where a model learns to improve itself using its predictions on unlabeled examples.

### RELATED APPLICATIONS

This application claims priority to and the benefit of U.S. Provisional Patent Application No. 63/194,474, filed May 28, 2021. U.S. Provisional Patent Application No. 63/194,474 is hereby incorporated by reference in its entirety.

### FIELD

The present disclosure relates generally to machine learning. More particularly, the present disclosure relates to systems and methods that leverage task-specific unlabeled data to improve downstream performance in data-constrained scenarios.

### BACKGROUND

Recent advances in natural language processing (NLP) demonstrate the effectiveness of applying large-scale Transformer language models to downstream tasks. While these models have achieved state-of-the-art results on many NLP benchmarks, they struggle when given limited training data for downstream (or “target”) tasks. For example, certain research has found that the BERT model is prone to degenerate performance on small datasets. While enormous language models like GPT-3 exhibit the ability to solve a new task from only a few examples without any fine-tuning, their performance still lags far behind state-of-the-art fine-tuning results. Manually annotating large amounts of training data will improve performance but can also be prohibitively expensive to obtain for many tasks and domains.

### SUMMARY

Aspects and advantages of embodiments of the present disclosure will be set forth in part in the following description, or can be learned from the description, or can be learned through practice of the embodiments.

One example aspect of the present disclosure is directed to computer-implemented method to enable improved learning with few training examples. The method includes obtaining, by a computing system comprising one or more computing devices, a set of unlabeled training data associated with a target task, the set of unlabeled training data comprising a plurality of unlabeled training examples that are in-domain for the target task. The method includes accessing, by the computing system, a first machine-learned model that has been previously trained using a set of labeled training data associated with a pre-training task that is different than the target task, the set of labeled training data comprising a plurality of labeled training examples that are out-of-domain for the target task. The method includes processing, by the computing system, each unlabeled training example with the first machine-learned model to respectively generate a synthetic supplement for each unlabeled training example, the plurality of training examples and synthetic supplements forming a set of synthetic training data. The method includes training, by the computing system, a second, different machine-learned model using the set of synthetic training data.

In some implementations, the set of labeled training data comprises a plurality of labeled natural language inference training examples, each labeled natural language inference training example comprising a first string of tokens, a second string of tokens, and a label that describes a relationship between the first string of tokens and the second string of tokens. In some implementations, the first machine-learned model comprises a generative language model that has been trained to process the first string of tokens and the label to predict the second string of tokens.

In some implementations, each unlabeled training example in the set of unlabeled training data comprises an unlabeled string of tokens. In some implementations, processing, by the computing system, each unlabeled training example with the first machine-learned model to respectively generate a synthetic supplement for each unlabeled training example comprises processing, by the computing system, each unlabeled string of tokens and a supplied label to generate a synthetic string of tokens.

In some implementations, processing, by the computing system, each unlabeled string of tokens and the supplied label to generate the synthetic string of tokens comprises processing, by the computing system, each unlabeled string of tokens and a plurality of different supplied labels to generate a plurality of different synthetic strings of tokens for each unlabeled string of tokens.

In some implementations, the method further comprises using, by the computing system, a third machine-learned model to filter the plurality of different synthetic strings of tokens.

In some implementations, using, by the computing system, the third machine-learned model to filter the plurality of different synthetic strings of tokens comprises: for each pair of unlabeled string of tokens and synthetic string of tokens: processing, by the computing system, the pair of unlabeled string of tokens and synthetic string of tokens with the third machine-learned model to generate a predicted label; and determining, by the computing system, whether the predicted label matches the supplied label that was supplied to generate the synthetic string of tokens.

In some implementations, using, by the computing system, the third machine-learned model to filter the plurality of different synthetic strings of tokens further comprises, for each pair of unlabeled string of tokens and synthetic string of tokens and when the predicted label matches the supplied label: determining, by the computing system, whether a confidence value output by the third machine-learned model for the predicted label satisfies a threshold value; when the confidence value output by the third machine-learned model for the predicted label satisfies the threshold value: maintaining, by the computing system, the pair of unlabeled string of tokens and synthetic string of tokens in the set of synthetic training data; and when the confidence value output by the third machine-learned model for the predicted label does not satisfy the threshold value: discarding, by the computing system, the pair of unlabeled string of tokens and synthetic string of tokens from the set of synthetic training data.

In some implementations, the method further comprises, after training, by the computing system, the second machine-learned model using the set of synthetic training data: training, by the computing system, the second machine-learned model using a second set of labeled training data associated with the target task, the second set of labeled training data comprising a second plurality of labeled training examples that are in-domain for the target task.

Another example aspect is directed to a computing system configured to perform improved learning with few training examples, the computing system comprising: one or more processors; and one or more non-transitory computer-readable media that collectively store instructions that when executed by the one or more processors cause the computing system to perform operations, the operations comprising: for each of a plurality of training iterations: accessing a current set of labeled training data associated with a target task, the current set of labeled training data comprising labeled training examples that are in-domain for the target task; training a base model using the current set of labeled training data to generate a current student model; accessing a set of unlabeled training data associated with the target task, the set of unlabeled training data comprising unlabeled training examples that are in-domain for the target task; processing each unlabeled training data with the current student model to respectively generate a synthetic label for each unlabeled training example, the unlabeled training examples and synthetic labels forming a set of self-labeled training data; and combining some or all of the set of self-labeled training data with an original set of labeled training data to generate the current set of labeled training data for a next training iteration of the plurality of training iterations; and after the plurality of training iterations, outputting the current student model as a output model.

In some implementations, the same base model is used at each of the plurality of training iterations. In some implementations, combining some or all of the set of self-labeled training data with the original set of labeled training data to generate the current set of labeled training data for the next training iteration comprises combining all of the set of self-labeled training data with the original set of labeled training data to generate the current set of labeled training data for the next training iteration. In some implementations, the base model comprises a base language model; and the target task comprises a natural language processing task.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A provides example experimental results that demonstrate that example implementations of the proposed Self-Training with Task Augmentation (STraTA) approach substantially improve sample efficiency across different tasks.

FIG. 1B provides an illustration of an example implementation of the proposed Self-Training with Task Augmentation (STraTA) approach according to example embodiments of the present disclosure.

FIGS. 2A-D depict block diagrams of an example task augmentation approach according to example embodiments of the present disclosure.

FIGS. 3A-E depict block diagrams of an example task augmentation approach applied in a natural language processing context according to example embodiments of the present disclosure.

FIGS. 4A-B depict block diagrams of an example self-learning approach according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods that leverage task-specific unlabeled data to improve downstream performance in data-constrained scenarios. Given a target task, a first technique proposed herein, which can be referred to as task augmentation, uses unlabeled text from the target domain to synthesize a large amount of in-domain training data for an auxiliary task. Task augmentation provides significant performance gains across different tasks, generally outperforming competing fine-tuning approaches. A second technique provides a self-training algorithm, where a model learns to improve itself using its predictions on unlabeled examples. Example experiments contained in the Appendix reveal that using a strong base model and training on a broad task distribution are important for successful self-training. These techniques are able to substantially improve sample efficiency for various tasks, e.g., demonstrated across 12 NLP benchmark datasets. For example, with only 8 training examples per class from the SST-2 sentiment dataset, example implementations of the present disclosure achieved comparable results to standard fine-tuning with 67K training examples. Thus, the present disclosure provides two complementary methods, task augmentation and self-training, to alleviate the need for labeled data by leveraging task-specific unlabeled data, which is comparatively cheap to obtain.

More particularly, task augmentation uses unlabeled text from the domain of a given target task to simulate a large amount of in-domain training data for the auxiliary task of natural language inference (NLI). Example approaches can first train an NLI data generator by fine-tuning a pre-trained generative language model on the MNLI dataset in a text-to-text format. Then, given a target task (e.g., sentiment analysis) with unlabeled text (e.g., his acting was really awful), the generative language model can be used to generate NLI examples such as [his acting was really awful, he gave an incredible performance, contradiction]. Finally, an additional model (e.g., a BERT model) can be fine-tuned on the newly-created auxiliary NLI dataset before the additional model is fine-tuned on the target task. Task augmentation significantly improves downstream performance across different tasks compared to other fine-tuning approaches.

A second approach, self-training, uses a model's predictions (e.g., a BERT model's predictions on unlabeled examples from the target task as pseudo-labels to augment the original labeled data set. In some implementations, self-training starts with a base model (e.g., the auxiliary task model that results from task augmentation) that is fine-tuned at each iteration using a concatenation of the labeled dataset and pseudo-labeled examples created from the previous training iteration. This procedure can be repeated for a number of iterations until a stopping criterion is reached. Example experiments reveal that using a strong base model and training on a broad task distribution are important factors for successful deployment in NLP.

Further, by combining task augmentation with self-training, example implementations of the present disclosure can significantly improve sample efficiency, in terms of both performance and variance, e.g., as empirically demonstrated across 12 NLP benchmark datasets. For example, on the sentiment analysis SST-2 dataset, with only 8 training examples per class, comparable results were achieved versus standard fine-tuning with 67K training examples.

The systems and methods of the present disclosure provide a number of technical effects and benefits. As one example technical effect, the systems and methods described herein can enable improved performance with fewer labeled training examples. This means that less effort (e.g., usage of computational resources) must be expended to create additional labeled training examples. Furthermore, the techniques described herein enable models to be quickly adapted to new tasks and domains. This enables models to be fine-tuned from a starting point rather than from scratch, which equates to fewer training iterations overall (e.g., a brand new model does not need to be generated for each task). Fewer training iterations overall corresponds to reduced usage of computational resources such as reduced processor usage, memory usage, and network bandwidth usage.

As another example improvement in the functioning of the computer, example implementations of the present disclosure can significantly improve sample efficiency, in terms of both performance and variance. Thus, the performance of a computer including a machine-learned model can be improved.

With reference now to the Figures, example embodiments of the present disclosure will be discussed in further detail.

### Example Learning Techniques

Despite their recent successes in tackling many NLP tasks, large-scale pre-trained language models do not perform as well in few-shot settings where only a handful of training examples are available. To address this shortcoming, example aspects of the present disclosure are directed to STraTA, which stands for Self-Training with Task Augmentation, an approach that builds on two key ideas for effective leverage of unlabeled data. First, STraTA uses task augmentation, a novel technique that synthesizes a large amount of data for auxiliary-task fine-tuning from target-task unlabeled texts. Second, STraTA performs self-training by further fine-tuning the strong base model created by task augmentation on a broad distribution of pseudo-labeled data. Example experiments contained in U.S. Provisional Patent Application No. 63/194,474 demonstrate that STraTA can substantially improve sample efficiency across 12 few-shot benchmarks. Remarkably, on the SST-2 sentiment dataset, STraTA, with only 8 training examples per class, achieves comparable results to standard fine-tuning with 67K training examples. Our analyses reveal that task augmentation and self-training are both complementary and independently effective.

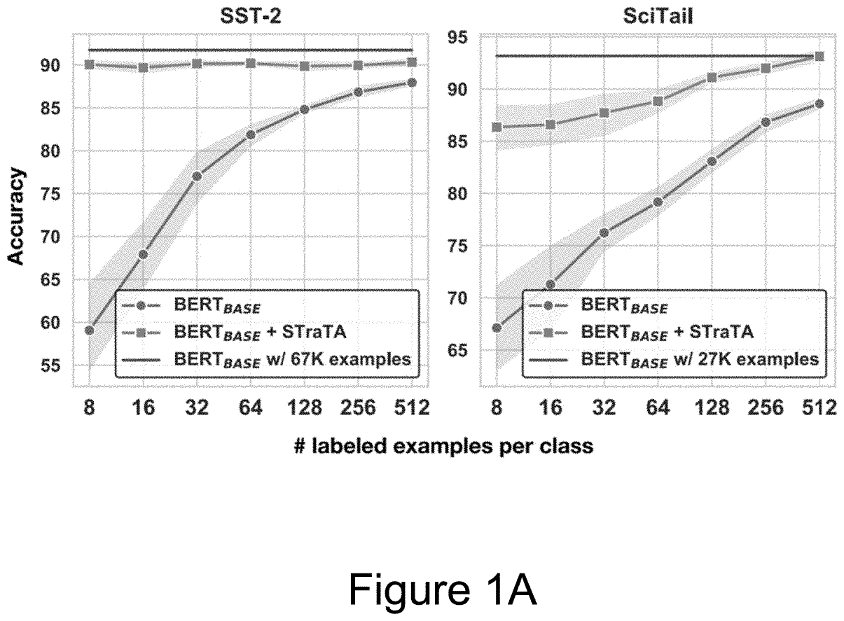

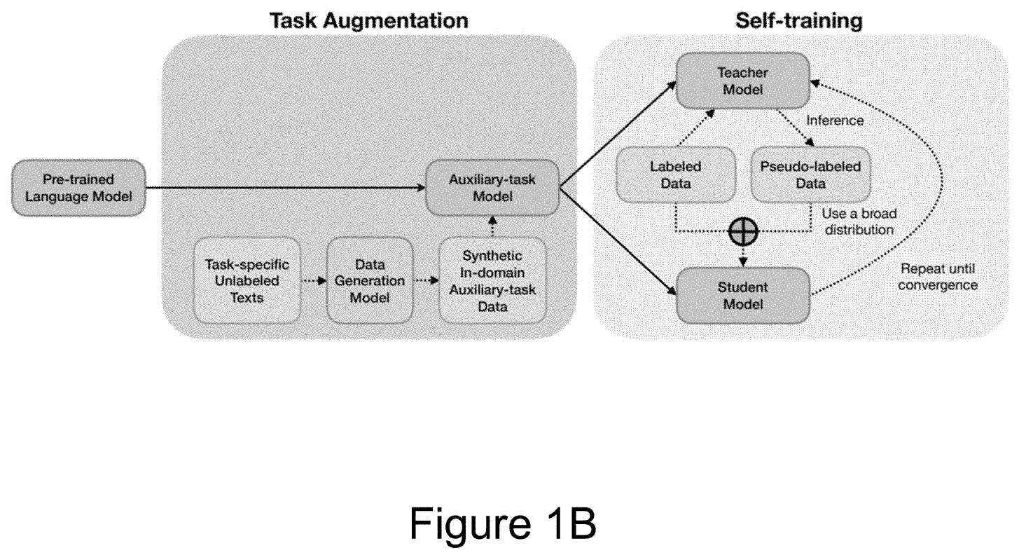

FIG. 1A provides example experimental results that demonstrate that example implementations of the proposed Self-Training with Task Augmentation (STraTA) approach substantially improve sample efficiency across different tasks. For example, when given only 8 labeled examples per class from the SST-2 sentiment dataset, example implementations of STraTA are competitive with standard fine-tuning on 67K examples; on the SciTail entailment dataset, with 512 labeled examples per class, example implementations of STraTA surpass standard fine-tuning on 27K examples.

FIG. 1B provides an illustration of one example of the proposed Self-Training with Task Augmentation (STraTA) approach. In task augmentation, a computing system can train an NLI data generation model and use it to synthesize a large amount of in-domain NLI training data for each given target task, which is then used for auxiliary (intermediate) fine-tuning. Some implementations of the self-training algorithm iteratively learn a better model using a concatenation of labeled and pseudo-labeled examples. At each iteration, example implementations can start with the auxiliary-task model produced by task augmentation and train on a broad distribution of pseudo-labeled data.

More generally, at a high level, task augmentation exploits unlabeled texts from the domain of a given target task to simulate a large amount of in-domain training data for the auxiliary task of natural language inference (NLI), which is then used to train a given model before applying it to the target task. To achieve this, example implementations can first build an NLI data generator by fine-tuning a pre-trained generative language model on the MNLI dataset in a text-to-text format. Then, given a target task (e.g., sentiment analysis) with unlabeled texts (e.g., his acting was really awful), example implementations can use the NLI data generator to generate NLI examples (e.g., [his acting was really awful, he gave an incredible performance, contradiction]). Task augmentation alone can significantly improve downstream performance across different tasks, generally outperforming other fine-tuning approaches, such as target-task language model fine-tuning and intermediate-task fine-tuning on MNLI, in both high- and low-data regimes.

Having obtained a strong auxiliary-task model with task augmentation, STraTA can use this model as a base model for self-training. Specifically, at each at iteration, the base model can be fine-tuned using the available labeled data for the target task. Then, the resulting model's predictions on unlabeled examples are used as pseudo-labels to augment the original labeled data set. The term unlabeled texts can refer to pieces of text (e.g., sentences) from the target domain, and the term unlabeled examples can refer to examples that can be annotated using the set of class labels for the target task.

The newly formed labeled data set can then be used to learn a better model in the next iteration, and this procedure can be repeated for a number of iterations until a stopping criterion is reached. While self-training has been extensively studied, example experiments reveal that using a strong base model and training on a broad distribution of pseudo-labeled data are key factors for successful deployment in NLP.

Using the example proposed STraTA approach, example implementations are able to significantly improve sample efficiency, in terms of both performance and variance, across 12 NLP benchmark datasets. For instance, on the SST-2 sentiment dataset, with only 8 training examples per class, example implementations achieve comparable results to standard fine-tuning with 67K training examples (see FIG. 1A).

Example contributions provided by the present disclosure include: Proposing task augmentation, a novel data augmentation-based fine-tuning method, and demonstrating its effectiveness in comparison to other competing fine-tuning approaches; Proposing a simple yet effective self-training algorithm and highlight important ingredients for successful self-training, which will enable the wider adoption of self-training in NLP; and With STraTA, example implementations demonstrate the effectiveness of combining task augmentation and self-training in improving sample efficiency across NLP benchmarks.

Example Task Augmentation

Labeled data is often expensive and time-consuming to obtain, which motivates approaches that learn from both labeled and unlabeled data. More formally, assume example implementations are given a target task T with a labeled data set L_{T}={(xᵢ, yᵢ)}ᵢ₌₁^{M} and an unlabeled data set U_{T}={(xⱼ)}ⱼ₌₁^{N}. The unlabeled data U_{T} can be created artificially by removing the ground-truth labels y from L_{T} (as in the main experiments), or it can come from additional unlabeled texts from the target domain or from related datasets/domains.

Some example implementations of the proposed methods, task augmentation and self-training, take advantage of the unlabeled data U_{T} to maximize performance on the target task T, even when the number of labeled examples M is small (e.g., M=16). In this section, example implementations first present a framework and implementation for task augmentation, which uses natural language inference (NLI) as an auxiliary (intermediate) training task to improve downstream performance.

Example framework for task augmentation: Task augmentation builds on a recent body of NLP research on intermediate-task training, in which a pre-trained language model, such as BERT, is fine-tuned on an auxiliary task before the target task. This process differs from traditional data augmentation approaches (e.g., lexical substitution, or back-translation), which yield negligible improvements when combined with large-scale pre-trained language models. In previous work on intermediate fine-tuning, the auxiliary dataset used is a fixed target task-independent dataset, such as MNLI or SQuAD. A limitation of this choice is the domain mismatch between the auxiliary and target tasks, which the example proposed task augmentation method addresses.

More specifically, example implementations fine-tune a pre-trained generative language model and use it to synthesize a large amount of in-domain training data from U_{T} for an auxiliary task A, which is then used to improve performance of a model on the target task T (FIG. 1B, left). In this work, example implementations use NLI as the auxiliary task for two main reasons: (1) NLI has been shown to be an effective auxiliary task for a variety of target tasks, and (2) existing NLI datasets contain large training sets, which allows for training a reliable data generator.

Generating synthetic NLI data: To obtain an NLI data generator, example implementations fine-tune the pre-trained T5-3B model on MNLI, which contains 393K sentence pairs labeled as {entailment, contradiction, neutral}. The T5-3B model is described at Raffel et al., Exploring the limits of transfer learning with a unified text-to-text transformer. Journal of Machine Learning Research (JMLR 2020), 21(140):1-67.

Some example implementations cast each MNLI training example (sent_{A}, sent_{B})→label into a text-to-text format (label, sent_{A})→sent_{B} to obtain fine-tuning examples that look like [entailment, the facts are accessible to you→you have access to the facts]. Some example implementations fine-tune a separate T5 model per class label. To overcome biases in MNLI where the hypotheses are usually shorter than the premises, example implementations also include reversed examples: (reversed label,sent_B)→sent_A.

Some example implementations fine-tune T5 on this dataset with a constant learning rate of 0.001 for 2¹⁶=65,536 steps using the Adafactor optimizer. The fine-tuned T5 data generator produces augmented examples for all target datasets. Specifically, at inference time, example implementations feed the model an NLI label (e.g., entailment) and an unlabeled sentence xⱼ from the target domain to produce some output sentence xₖ: (entailment, xⱼ)→xₖ. Data for intermediate fine-tuning can then be formed by creating examples like (xⱼ, xₖ)→entailment. This approach has several advantages: (1) training labels are free, and (2) by using overgeneration, example implementations can produce a large amount of in-domain NLI training data even for target tasks with small datasets.

Overgeneration and filtering: Some example implementations perform overgeneration and filtering to increase the quantity and quality of the synthetic NLI training data. Concretely, example implementations generate 100 output samples per input with top-k (k=40) sampling (duplicates are removed) and use a BERT model fine-tuned on MNLI (in the original format) as an NLI classifier to filter synthetic training examples. Some example implementations keep a synthetic example if the NLI classifier produces the same label as that fed to the NLI data generator and is also confident about its prediction.

Some example implementations use an example when its predicted probability exceeding a certain threshold τ. Some example implementations use a value for τ in [0.3, 0.4, . . . , 0.9] for each target task based on performance on the original MNLI development set. Intermediate fine-tuning can be performed on examples from both the original MNLI dataset and the final filtered task augmentation dataset. Some example implementations use a two-stage intermediate fine-tuning procedure where the model is first trained on the synthetic data before being fine-tuned on the original data typically works better, and this is used in our experiments.

Example Self-Training

While task augmentation uses unlabeled texts to produce synthetic data for an intermediate task, self-training is a complementary approach that improves a model by training directly on the target task using pseudo-labeled examples. Some example implementations use a simple self-training algorithm in which a model learns to improve itself using its predictions on unlabeled examples from a given target task. Some example implementations of the proposed method differ from traditional self-training methods in that example implementations leverage a strong base model and allow it to learn from all available pseudo-labeled examples at every iteration, regardless of model confidence. Formally, given a target task T with a small labeled data set L={(xᵢ, yᵢ)}ᵢ₌₁^{M} and an unlabeled data set U={(xⱼ)}ⱼ₌₁^{N}, where M<<N.

Algorithm 1: Example Self-Training Algorithm

### Initialization

t=0
Form a base model f₀, which is initialized with pre-trained parameters from a pre-training/intermediate fine-tuning stage, and then learn a teacher model f₁ by training f₀ on the original labeled data set L.
   repeat

t=t+1
Use the current teacher model fₜ to annotate (for t=1) or re-annotate (for t>1) all of the examples in U to obtain a set Ũ of pseudo-labeled examples.
Add the whole set Ũ of pseudo-labeled examples to the original labeled data set L to form a new labeled data set.
Learn a student model fₜ₊₁ by training the base model f₀ on the current labeled data set and optionally fine-tune it on L. The resulting student model fₜ₊₁ is used as a teacher for the next iteration.

### Until Convergence or the Maximum Number of Iterations is Reached

Starting with a strong base model: An important ingredient in self-training algorithms is the base model f₀. Successful self-training typically requires a good base model, which can provide a large proportion of “correct” predictions or pseudo-labels on unlabeled examples; otherwise, errors can be propagated or magnified in later stages of self-training. At each self-training iteration, some example implementations always start from the same base model f₀, which is initialized with pre-trained parameters from a pre-training/intermediate fine-tuning stage (e.g., the auxiliary task training stage in task augmentation), and then fine-tune all of its parameters using the available labeled and pseudo-labeled data.

Self-training on a broad distribution of pseudo-labeled data: Another important factor is the selection of pseudo-labeled examples at each self-training iteration. Traditional self-training approaches usually select a small set of examples where the current teacher model fₜ is highly confident (e.g., the probability of the predicted class label is above a threshold) to add to the labeled data set at each iteration until the unlabeled data pool U is exhausted. This can be problematic as state-of-the-art language models like BERT are overconfident and poorly calibrated.

To resolve these issues, some example implementations encourage learning from a “natural” broad distribution of pseudo-labeled data by adding the whole set Ũ of pseudo-labeled examples to the original labeled data set L at each self-training iteration. Removing examples with the lowest-confidence pseudo labels can be helpful for some tasks. One can use a development set, upon availability, to assess if this filtering is necessary. At each iteration t>1, example implementations also re-annotate all of the examples in the original unlabeled data pool U with fₜ, as example implementations expect fₜ is better than fₜ₋₁.

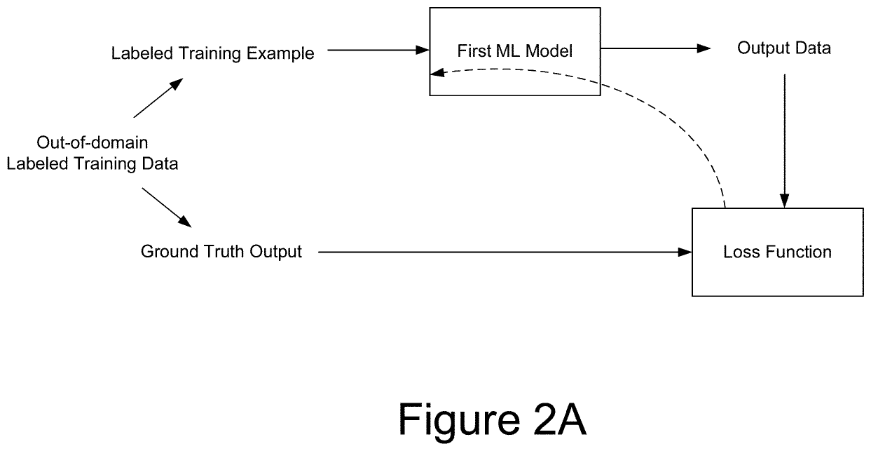

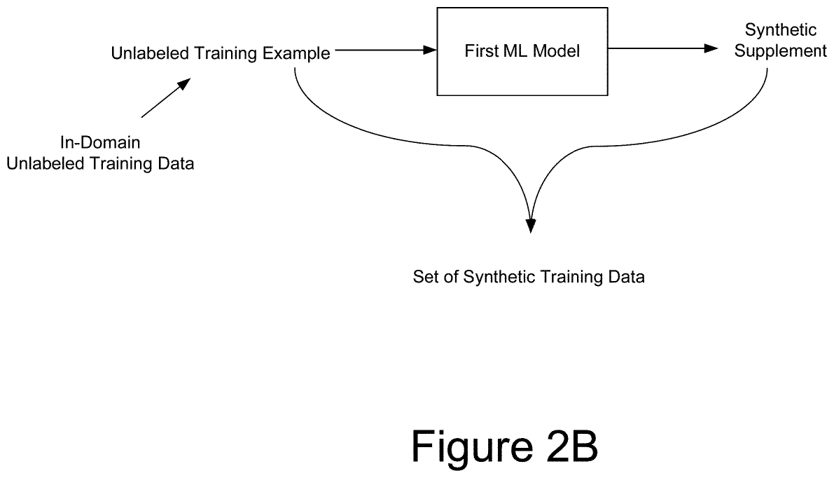

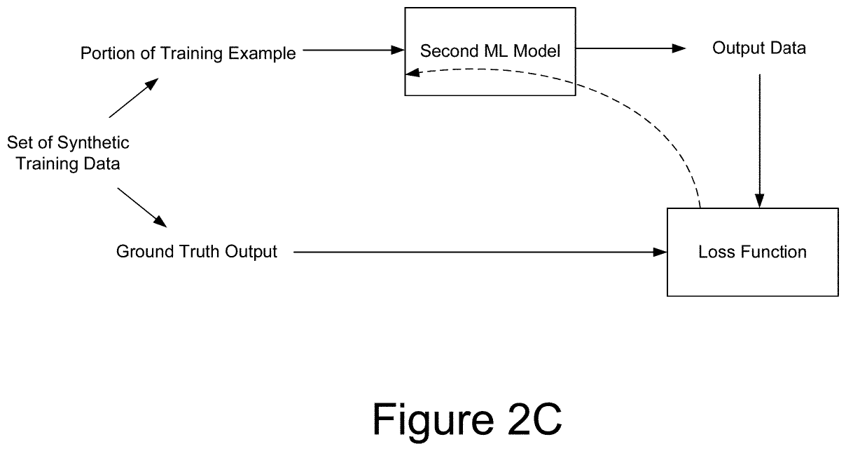

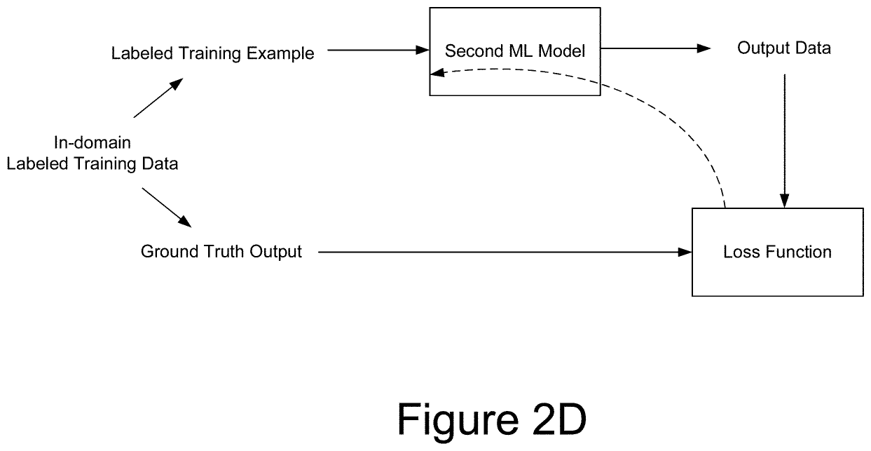

FIGS. 2A-D show an example task augmentation process according to example implementations of the present disclosure. In particular, at FIG. 2A, a first machine-learned model is shown being trained using a set of labeled training data associated with a pre-training task. The set of labeled training data is generally out-of-distribution relative to a downstream target task.

At FIG. 2B, the first machine-learned model (e.g., from FIG. 2A) is shown being used to generate a synthetic supplement for an unlabeled training example from a set of unlabeled training data that is in-domain relative to the target task, which is different from the pre-training task. The synthetic supplement for each unlabeled training example can be combined or associated with the unlabeled training example to generate a set of synthetic training data.

At FIG. 2C, a second machine-learned model is shown being trained using the set of synthetic training data (e.g., from FIG. 2B).

At FIG. 2D, the second machine-learned model is shown being further trained on a set of labeled training data that is in-domain relative to the target task.

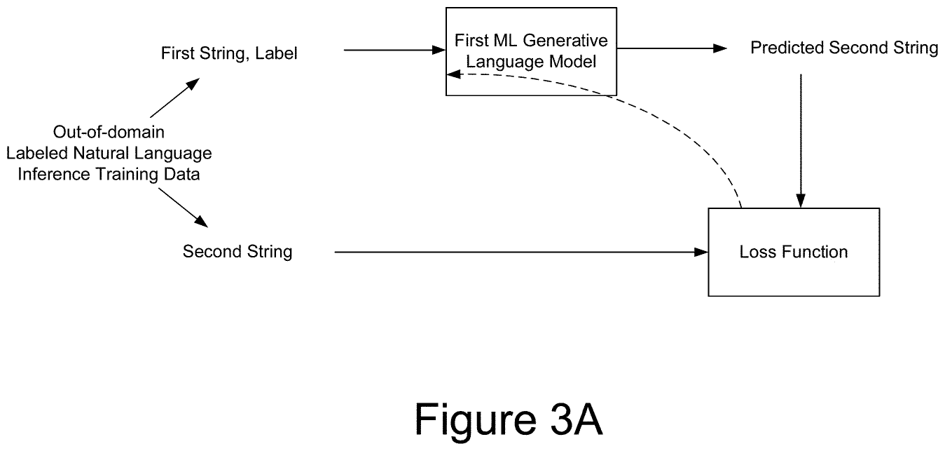

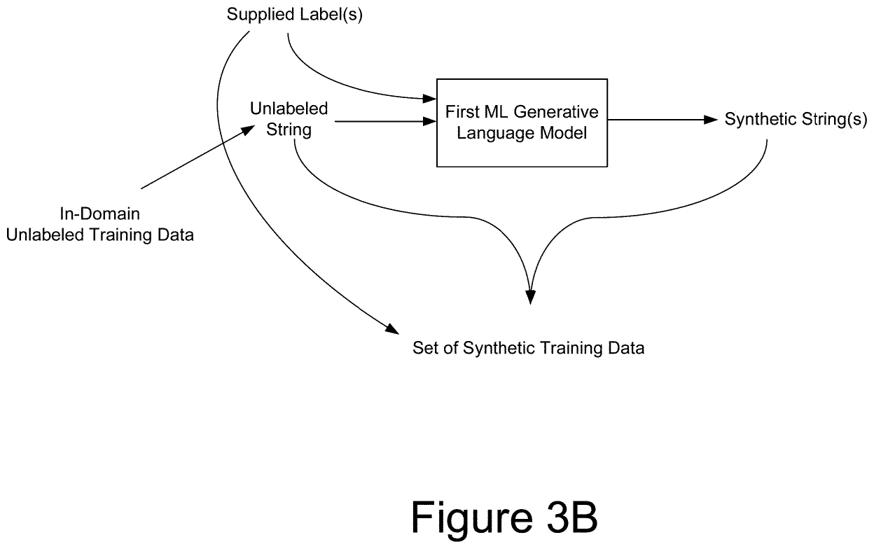

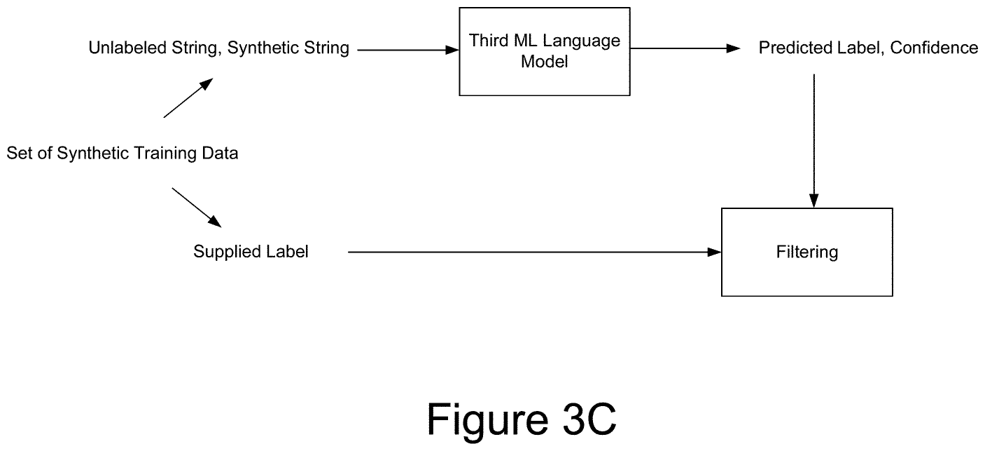

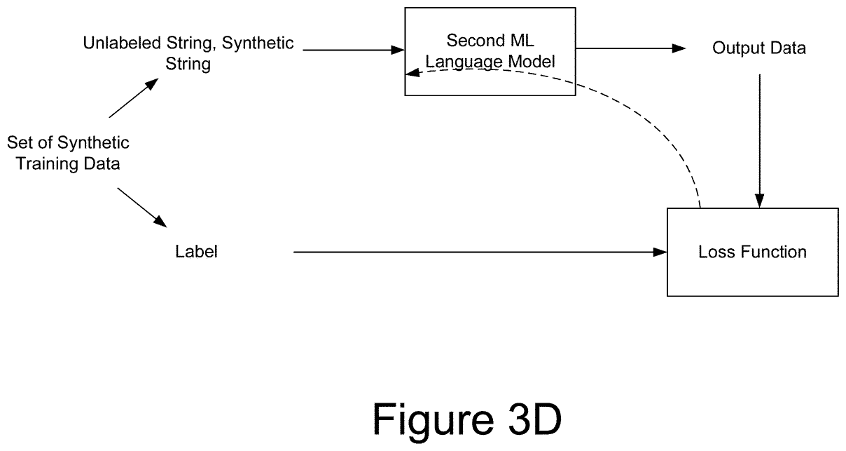

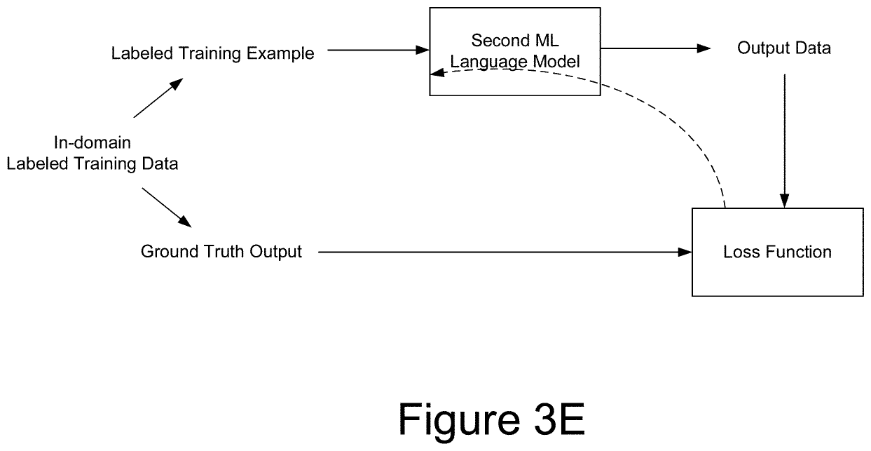

FIGS. 3A-E show an example task augmentation process applied to natural language processing according to example implementations of the present disclosure. In particular, at FIG. 3A, a first machine-learned generative language model is shown being trained using a set of labeled natural language inference training data associated with a pre-training task. The set of labeled training data is generally out-of-distribution relative to a downstream target task.

In particular, as shown in FIG. 3A, each training example from the set of labeled natural language inference can include a first string of tokens, a second string of tokens, and a label that describes a relationship between the first string of tokens and the second string of tokens. In the scheme shown in FIG. 3A, the first machine-learned generative language model processes the first string and the label to generate a predicted second string. The predicted second string can be compared to the ground truth second string to train the first machine-learned generative language model.

At FIG. 3B, the first machine-learned generative language model (e.g., from FIG. 3A) is shown being used to generate a synthetic supplement for an unlabeled training example from a set of unlabeled training data that is in-domain relative to the target task, which is different from the pre-training task. In particular, given an unlabeled string and supplied label, the first machine-learned generative language model can generate a synthetic string that has the supplied label relationship to the first string. The synthetic string for each unlabeled string can be combined or associated with the unlabeled string to generate a set of synthetic training data. In some implementations, multiple different supplied labels can be provided (e.g., sequentially over different inference iterations) to generate multiple synthetic strings with different relationships to the unlabeled strings, thereby generating a large number of synthetic training examples.

At FIG. 3C, a third machine-learned language model is shown being used to filter the set of synthetic training data. For example using the third machine-learned model to filter the plurality of different synthetic strings of tokens can include the following for each pair of unlabeled string of tokens and synthetic string of tokens: processing the pair of unlabeled string of tokens and synthetic string of tokens with the third machine-learned model to generate a predicted label; and determining whether the predicted label matches the supplied label that was supplied to generate the synthetic string of tokens. In some implementations, if the predicted label matches the supplied label, then the pair can be retained. Conversely, if the predicted label does not match the supplied label, then the pair can be discarded.

In some implementations, if the predicted label matches the supplied label then a further evaluation step can be performed. For example, when the predicted label matches the supplied label the computing system can determine whether a confidence value output by the third machine-learned model for the predicted label satisfies a threshold value. When the confidence value output by the third machine-learned model for the predicted label satisfies the threshold value, the pair of unlabeled string of tokens and synthetic string of tokens can be maintained in the set of synthetic training data. Conversely, when the confidence value output by the third machine-learned model for the predicted label does not satisfy the threshold value, the pair of unlabeled string of tokens and synthetic string of tokens can be discarded from the set of synthetic training data.

At FIG. 3D, a second machine-learned model is shown being trained using the set of synthetic training data (e.g., the data FIG. 3B or the filtered data from FIG. 3C). In particular, the second machine-learned language model can process the unlabeled string and the synthetic string to generate an output. The output can be compared to a label (e.g., the supplied label or the predicted label) to train the second machine-learned language model. At FIG. 3E, the second machine-learned model is shown being further trained on a set of labeled training data that is in-domain relative to the target task.

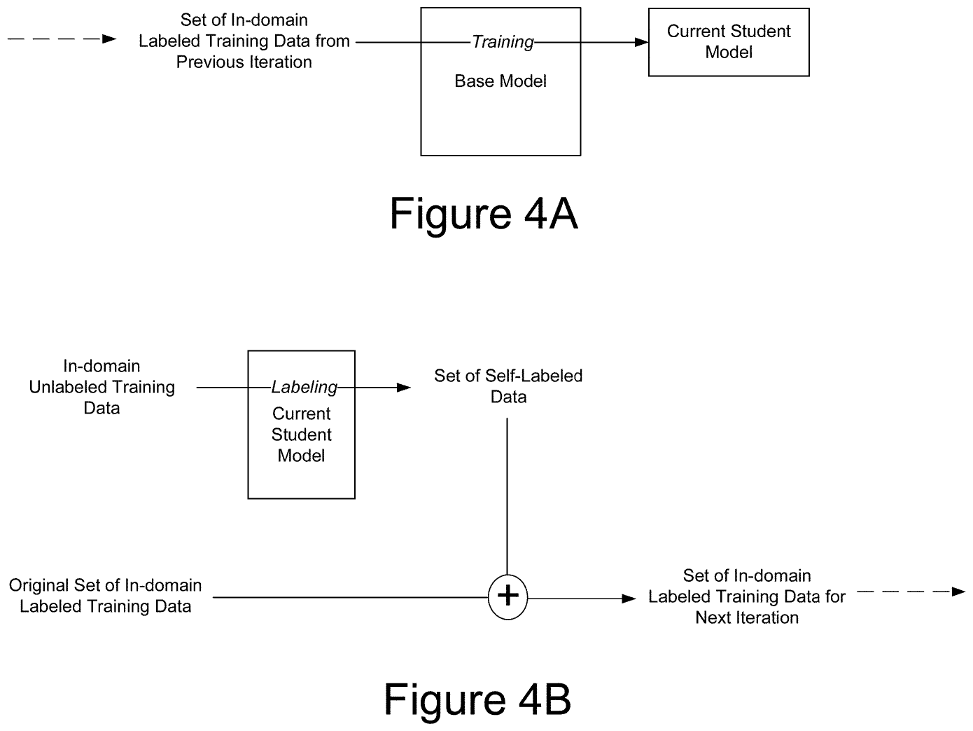

FIGS. 4A-B depict block diagrams of an example self-learning approach according to example embodiments of the present disclosure. The operations shown in FIGS. 4A-B can be performed at each of a plurality of training iterations.

In particular, at FIG. 4A, a base model can be trained using a current set of labeled training data associated with a target task. The current set of labeled training data can include labeled training examples that are in-domain for the target task. The labeled training examples can be actual labels or can be pseudo-labels generated from a previous training iteration.

The base model can be trained using the current set of labeled training data to generate a current student model. In some implementations, a same base model (e.g., having the same parameter values) can be used as the starting point of every iteration. In some implementations, the base model can be the second machine-learned model after the training shown in FIG. 2D or 3E.

Turning to FIG. 4B, the operations can include accessing a set of unlabeled training data associated with the target task. The set of unlabeled training data can include unlabeled training examples that are in-domain for the target task. The operations can include processing each unlabeled training data with the current student model to respectively generate a synthetic label for each unlabeled training data. In particular, the unlabeled training examples and synthetic labels can be combined or associated to form a set of self-labeled training data.

Finally, as shown in FIG. 4B, the self-learning technique can include inserting some or all of the set of self-labeled training data into an original set of labeled training data to create the current set of in-domain labeled training data for a next training iteration of the plurality of training iterations (e.g., returning to the steps shown in FIG. 4A). After the plurality of training iterations (e.g., when a stopping condition is met), the technique can include outputting the current student model as a output model.

### Example Devices and Systems

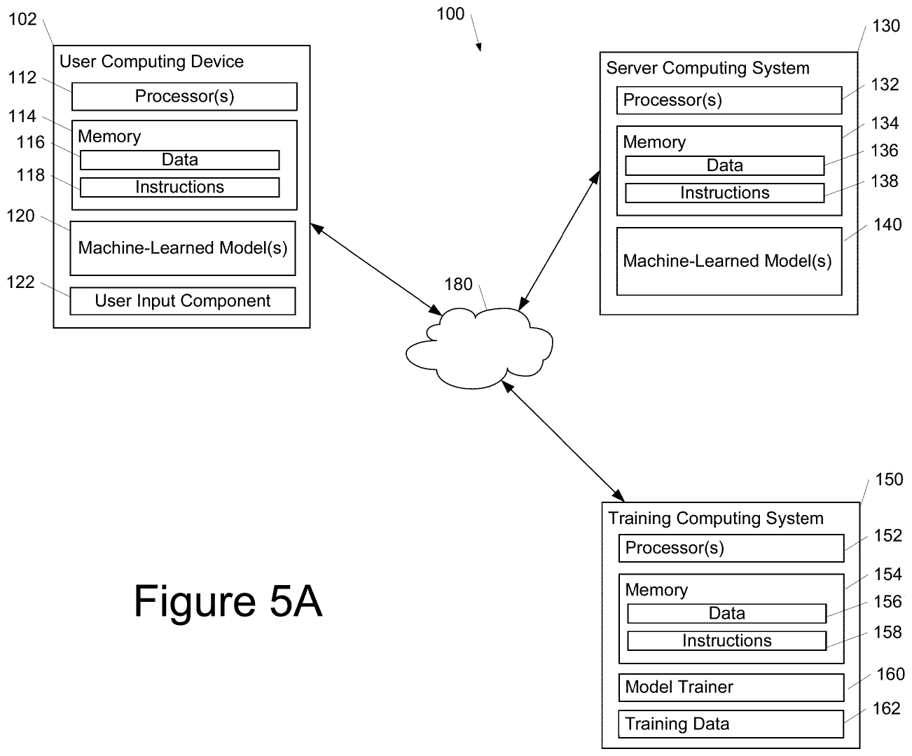

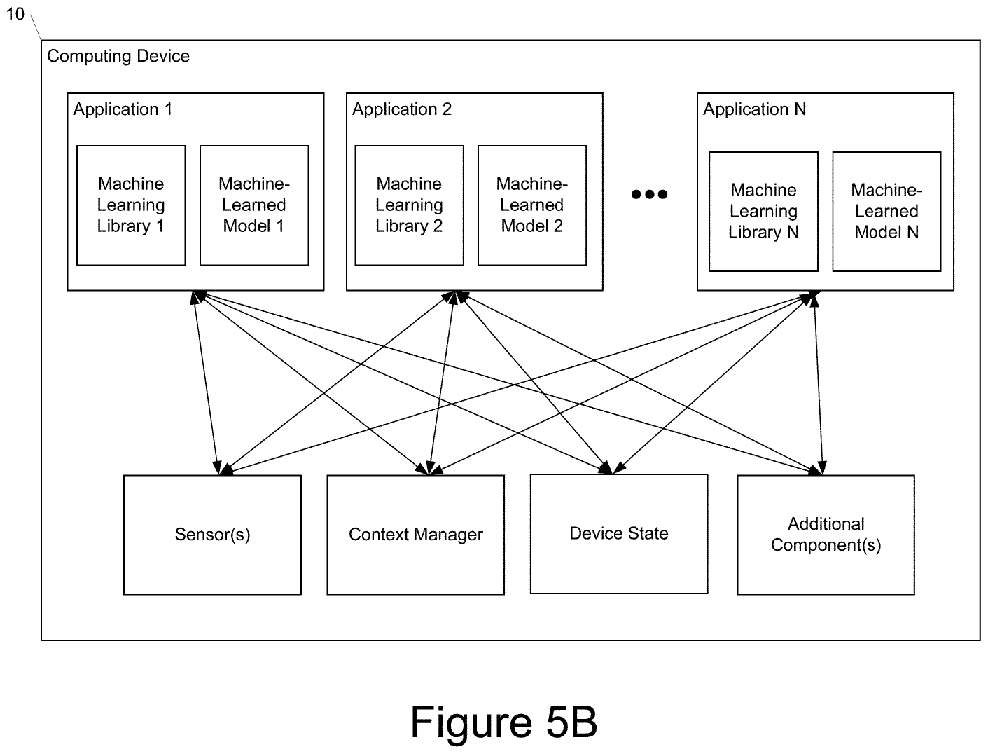

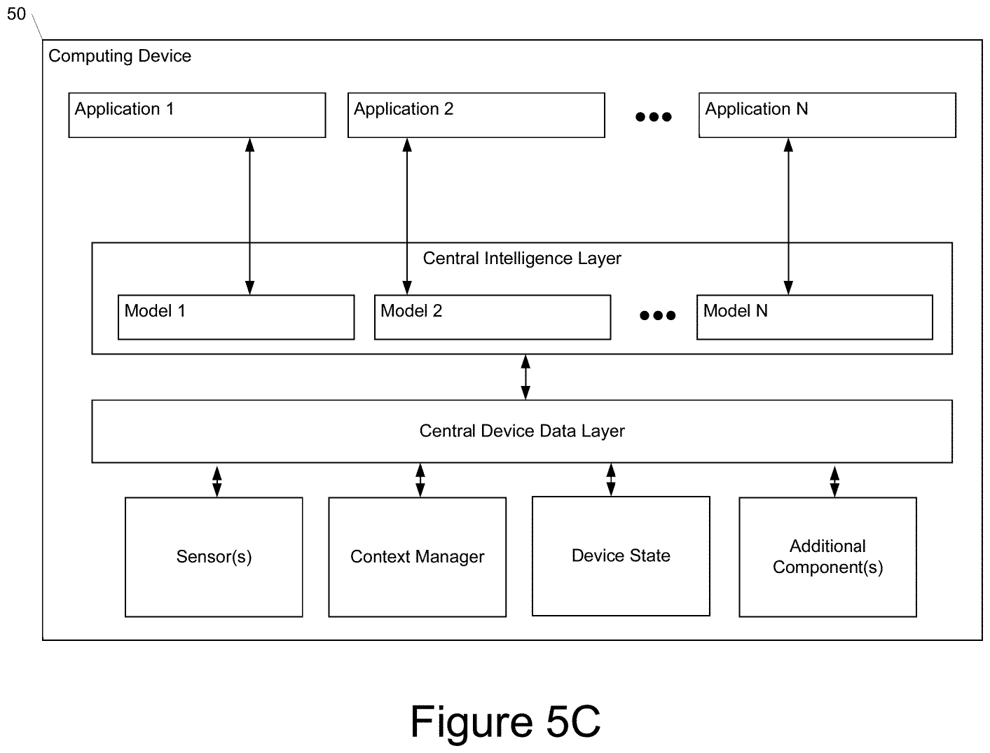

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 2A-4B.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel tasks across multiple instances of the model).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., an NLP service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2A-4B.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a re-clustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to enable improved learning with few training examples, the method comprising:
obtaining, by a computing system comprising one or more computing devices, a set of unlabeled training data associated with a target task, the set of unlabeled training data comprising a plurality of unlabeled training examples that are in-domain for the target task;
accessing, by the computing system, a first machine-learned model that has been previously trained using a set of labeled training data associated with a pre-training task that is different than the target task, the set of labeled training data comprising a plurality of labeled training examples that are out-of-domain for the target task;
processing, by the computing system, each unlabeled training example with the first machine-learned model to respectively generate a synthetic supplement for each unlabeled training example, the plurality of training examples and synthetic supplements forming a set of synthetic training data; and
training, by the computing system, a second, different machine-learned model using the set of synthetic training data.

2. The computer-implemented method of claim 1, wherein:
the set of labeled training data comprises a plurality of labeled natural language inference training examples, each labeled natural language inference training example comprising a first string of tokens, a second string of tokens, and a label that describes a relationship between the first string of tokens and the second string of tokens; and
the first machine-learned model comprises a generative language model that has been trained to process the first string of tokens and the label to predict the second string of tokens.

3. The computer-implemented method of claim 1, wherein:
each unlabeled training example in the set of unlabeled training data comprises an unlabeled string of tokens; and
processing, by the computing system, each unlabeled training example with the first machine-learned model to respectively generate a synthetic supplement for each unlabeled training example comprises processing, by the computing system, each unlabeled string of tokens and a supplied label to generate a synthetic string of tokens.

4. The computer-implemented method of claim 3, wherein processing, by the computing system, each unlabeled string of tokens and the supplied label to generate the synthetic string of tokens comprises processing, by the computing system, each unlabeled string of tokens and a plurality of different supplied labels to generate a plurality of different synthetic strings of tokens for each unlabeled string of tokens.

5. The computer-implemented method of claim 4, further comprising:
using, by the computing system, a third machine-learned model to filter the plurality of different synthetic strings of tokens.

6. The computer-implemented method of claim 5, wherein using, by the computing system, the third machine-learned model to filter the plurality of different synthetic strings of tokens comprises:
for each pair of unlabeled string of tokens and synthetic string of tokens:
processing, by the computing system, the pair of unlabeled string of tokens and synthetic string of tokens with the third machine-learned model to generate a predicted label; and
determining, by the computing system, whether the predicted label matches the supplied label that was supplied to generate the synthetic string of tokens.

7. The computer-implemented method of claim 6, wherein using, by the computing system, the third machine-learned model to filter the plurality of different synthetic strings of tokens further comprises, for each pair of unlabeled string of tokens and synthetic string of tokens and when the predicted label matches the supplied label:
determining, by the computing system, whether a confidence value output by the third machine-learned model for the predicted label satisfies a threshold value;
when the confidence value output by the third machine-learned model for the predicted label satisfies the threshold value: maintaining, by the computing system, the pair of unlabeled string of tokens and synthetic string of tokens in the set of synthetic training data; and
when the confidence value output by the third machine-learned model for the predicted label does not satisfy the threshold value: discarding, by the computing system, the pair of unlabeled string of tokens and synthetic string of tokens from the set of synthetic training data.

8. The computer-implemented method of claim 1, further comprising, after training, by the computing system, the second machine-learned model using the set of synthetic training data:
training, by the computing system, the second machine-learned model using a second set of labeled training data associated with the target task, the second set of labeled training data comprising a second plurality of labeled training examples that are in-domain for the target task.

9. A computing system configured to perform improved learning with few training examples, the computing system comprising:
one or more processors; and
one or more non-transitory computer-readable media that collectively store instructions that when executed by the one or more processors cause the computing system to perform operations, the operations comprising:
for each of a plurality of training iterations:
accessing a current set of labeled training data associated with a target task, the current set of labeled training data comprising labeled training examples that are in-domain for the target task;
training a base model using the current set of labeled training data to generate a current student model;
accessing a set of unlabeled training data associated with the target task, the set of unlabeled training data comprising unlabeled training examples that are in-domain for the target task;
processing each unlabeled training data with the current student model to respectively generate a synthetic label for each unlabeled training example, the unlabeled training examples and synthetic labels forming a set of self-labeled training data; and
combining some or all of the set of self-labeled training data with an original set of labeled training data to generate the current set of labeled training data for a next training iteration of the plurality of training iterations; and
after the plurality of training iterations, outputting the current student model as a output model.

10. The computing system of claim 9, wherein the base model comprises a self-trained model.

11. The computing system of claim 9, wherein the same base model is used at each of the plurality of training iterations.

12. The computing system of claim 9, wherein combining some or all of the set of self-labeled training data with the original set of labeled training data to generate the current set of labeled training data for the next training iteration comprises combining all of the set of self-labeled training data with the original set of labeled training data to generate the current set of labeled training data for the next training iteration.

13. The computing system of claim 9, wherein:
the base model comprises a base language model; and
the target task comprises a natural language processing task.

14. One or more non-transitory computer-readable media that collectively store instructions that, when executed by a computing system comprising one or more computers, cause the computing system to perform operations, the operations comprising:
obtaining, by the computing system, a set of unlabeled training data associated with a target task, the set of unlabeled training data comprising a plurality of unlabeled training examples that are in-domain for the target task;
accessing, by the computing system, a first machine-learned model that has been previously trained using a set of labeled training data associated with a pre-training task that is different than the target task, the set of labeled training data comprising a plurality of labeled training examples that are out-of-domain for the target task;
processing, by the computing system, each unlabeled training example with the first machine-learned model to respectively generate a synthetic supplement for each unlabeled training example, the plurality of training examples and synthetic supplements forming a set of synthetic training data; and
training, by the computing system, a second, different machine-learned model using the set of synthetic training data.

15. The one or more non-transitory computer-readable media of claim 14, wherein:
the set of labeled training data comprises a plurality of labeled natural language inference training examples, each labeled natural language inference training example comprising a first string of tokens, a second string of tokens, and a label that describes a relationship between the first string of tokens and the second string of tokens; and
the first machine-learned model comprises a generative language model that has been trained to process the first string of tokens and the label to predict the second string of tokens.

16. The one or more non-transitory computer-readable media of claim 14, wherein:
each unlabeled training example in the set of unlabeled training data comprises an unlabeled string of tokens; and
processing, by the computing system, each unlabeled training example with the first machine-learned model to respectively generate a synthetic supplement for each unlabeled training example comprises processing, by the computing system, each unlabeled string of tokens and a supplied label to generate a synthetic string of tokens.

17. The one or more non-transitory computer-readable media of claim 16, wherein processing, by the computing system, each unlabeled string of tokens and the supplied label to generate the synthetic string of tokens comprises processing, by the computing system, each unlabeled string of tokens and a plurality of different supplied labels to generate a plurality of different synthetic strings of tokens for each unlabeled string of tokens.

18. The one or more non-transitory computer-readable media of claim 17, wherein the operations further comprise:
using, by the computing system, a third machine-learned model to filter the plurality of different synthetic strings of tokens.

19. The one or more non-transitory computer-readable media of claim 18, wherein using, by the computing system, the third machine-learned model to filter the plurality of different synthetic strings of tokens comprises:
for each pair of unlabeled string of tokens and synthetic string of tokens:
processing, by the computing system, the pair of unlabeled string of tokens and synthetic string of tokens with the third machine-learned model to generate a predicted label; and
determining, by the computing system, whether the predicted label matches the supplied label that was supplied to generate the synthetic string of tokens.

20. The one or more non-transitory computer-readable media of claim 14, wherein the operations further comprise, after training, by the computing system, the second machine-learned model using the set of synthetic training data:
training, by the computing system, the second machine-learned model using a second set of labeled training data associated with the target task, the second set of labeled training data comprising a second plurality of labeled training examples that are in-domain for the target task.
